(19) United States
(12) Patent Application Publication
(10) Pub. No.: US 2021/0327232 A1
(43) Pub. Date: Oct. 21, 2021

(54) APPARATUS AND A METHOD FOR ADAPTIVELY MANAGING EVENT-RELATED DATA IN A CONTROL ROOM

(71) Applicant: NEC Corporation, Minato-ku, Tokyo (JP)

(72) Inventors: Albert Hardy TANUTAMA, Singapore (SG); Slow Meng LOW, Singapore (SG)

(73) Assignee: NEC Corporation, Minato-ku, Tokyo (JP)

(21) Appl. No.: 17/272,988

(22) PCT Filed: Aug. 16, 2019
(86) PCT No.: PCT/JP2019/032162

§ 371 Date: Mar. 3, 2021

(30) Foreign Application Priority Data
Sep. 5, 2018 (SG) 10201807628X

(51) Int. Cl. G08B 13/196

(52) U.S. Cl. CPC G08B 13/19613; G08B 13/19682; G08B 13/19671

(57) ABSTRACT

The present disclosure provides a method for adaptively managing event-related data in a control room. The method comprising receiving, from an input capturing device, an input relating to an event; determining a location information and a time information in response to the receipt of the input; determining a pre-determined attribute of the input, the pre-determined attribute determining at least a type of the event; and determining a presentation of the event in response to the determination of the location information, the time information and the pre-determined attribute of the input.

### TECHNICAL FIELD

The present invention relates to an apparatus and a method for adaptively managing event-related data. In particular, this invention relates to adaptive monitoring and analyzing of real-time event-related data in a control room.

### BACKGROUND ART

The explosive growth and widespread variety of spatio-temporal data collection from sensor devices in a surveillance system has raised the demand in spatio-temporal data analytic approaches. There are various useful and important information included in the huge collections of data which could provide valuable knowledge that can advance an understanding of the complex phenomena to be observed in a surveillance system. Finding ways to harness the useful information that lies hidden in these large data repositories and turning these into knowledge and action is of major interest to key stakeholders such as the government bodies and corporations to enable faster sensing, analysis and response to abnormal situations in control room operations.

### SUMMARY OF INVENTION

### Technical Problem

Spatio-temporal data consists of three main components: spatial (location), time and multivariate categorical attributes describing various properties of an event. These various components of the spatio-temporal data makes it difficult, if not impossible, to use standard techniques of statistical analysis. Particularly, various research papers have highlighted the problems and difficulties of analysing spatio-temporal data due to spatial and temporal dependencies where standard statistical analysis techniques only assume independence among observations. Furthermore, the complex dependencies, heterogeneity and large volume of multivariate spatio-temporal data make behaviour (patterns and structure) exploration and analysis challenging. Two key considerations include computational efficiency and visual effectiveness problems. Conventional techniques are unable to break down the high volume of data to each component to analyze accurately.

In addition to volume and variety that characterize much of the modern real-world data, velocity and volatility are key attributes of streaming data. High-velocity data leads to frequent updates that are hard for a human to track while high volatility of the data implies unknown baseline behaviour that can make it difficult for analysts to understand the causes and implications of the changes.

As stated in the above, most of the monitoring and exploratory analysis techniques have limited ability to handle streaming (continuous) and fragmentary (incomplete and uncertain) large-scale spatio-temporal data in a real-time situation. Many existing analysis and visualization methods rely on pre-processed, cleaned up, static data sets which only work in the absence of corrupted, missing, outlier data points. Hence, adaptively processing real-time data results in major challenges for visual analysis methods because there is neither time nor the whole dataset available to perform manual pre-processing.

It is an object of the present invention to substantially overcome, or at least ameliorate, one or more existing problems.

### Solution to Problem

According to a first aspect of the present disclosure, there is provided a method for adaptively managing events in a control room, the method comprising receiving, from an input capturing device, an input relating to an event; determining a location information and a time information in response to the receipt of the input; determining a pre-determined attribute of the input, the pre-determined attribute determining at least a type of the event; and determining a presentation of the event in response to the determination of the location information, the time information and the pre-determined attribute of the input.

According to a second aspect of the present disclosure, there is provided an apparatus for adaptively managing events in a control room, the apparatus comprising a memory in communication with a processor, the memory storing a computer program recorded therein, the computer program being executable by the processor to cause the apparatus at least to receive, from a plurality of input capturing devices, a plurality of inputs, each of the plurality of inputs relating to at least one event; determine a plurality of location information and a plurality of time information in response to the receipt of the plurality of inputs, each of the plurality of location information and the plurality of time information corresponding to one of the plurality of the inputs; determine a plurality of pre-determined attributes of the plurality of inputs, each of the plurality of pre-determined attributes determining at least a type of the at least one event; and determine a plurality of presentation of the one or more events in response to the determination of the plurality of location information, the plurality of time information and the plurality of pre-determined attribute of the plurality of inputs.

According to yet another aspect of the present disclosure, there is provided a system for adaptively managing events, the system comprising the apparatus in the second aspect and at least one of an input capturing device and a peripheral device in communication with the processor, wherein the peripheral device is configured to generate alerts in the control room.

Other embodiments are also disclosed.

### BRIEF DESCRIPTION OF DRAWINGS

Embodiments of the invention will be better understood and readily apparent to one of ordinary skill in the art from the following written description, which provides examples only, and in conjunction with the drawings in which:

FIG. 1 shows a block diagram illustrating a system for adaptively managing event-related data in a control room according to an embodiment.

FIG. 2A shows a flow diagram illustrating a method for adaptively managing event-related data in a control room according to an embodiment.

FIG. 2B shows a flow diagram illustrating a part of a method for adaptively managing event-related data in a control room according to an embodiment.

FIG. 3 shows an illustration of system components for adaptively managing event-related data in a control room according to an embodiment.

FIG. 4 shows a block diagram illustrating how event-related data may be adaptively managed according to an embodiment.

FIG. 5A shows how location information, time information and pre-determined attributes information may be grouped respectively.

FIG. 5B shows how location information, time information and pre-determined attributes information may be grouped respectively.

FIG. 5C shows how location information, time information and pre-determined attributes information may be grouped respectively.

FIG. 6 illustrates an example of multilevel grouping using hierarchical data structure according to an embodiment and an example of how event data may be grouped according to an embodiment in comparison to a conventional method.

FIG. 7 shows an example of event-related data presented in a data stream and a score table.

FIG. 8 illustrates an example of how inputs may be processed in an embodiment.

FIG. 9A illustrates an example of an occurrence matrix, a recency matrix, a score matrix and a final event importance score matrix respectively.

FIG. 9B illustrates an example of an occurrence matrix, a recency matrix, a score matrix and a final event importance score matrix respectively.

FIG. 9C illustrates an example of an occurrence matrix, a recency matrix, a score matrix and a final event importance score matrix respectively.

FIG. 9D illustrates an example of an occurrence matrix, a recency matrix, a score matrix and a final event importance score matrix respectively.

FIG. 10A shows an example of an event importance score matrix in comparison to a conventional score matrix.

FIG. 10B shows an example of an event importance score matrix in comparison to a conventional score matrix.

FIG. 11A shows examples of how events are handled using a method for adaptively managing event-related data in a control room according to an embodiment.

FIG. 11B shows examples of how events are handled using a method for adaptively managing event-related data in a control room according to an embodiment.

FIG. 11C shows examples of how events are handled using a method for adaptively managing event-related data in a control room according to an embodiment.

FIG. 12 illustrates an example of how events may be presented in a control room according to an embodiment.

### DESCRIPTION OF EMBODIMENTS

Overview

Embodiments of the present invention will be described, by way of example only, with reference to the drawings. Like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, “receiving”, “retrieving”, “identifying”, “predicting” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

It is to be noted that the discussions contained in the “Background” section and that above relating to conventional methods relate to discussions of devices which form public knowledge through their use. Such should not be interpreted as a representation by the present inventor(s) or the patent applicant that such devices in any way form part of the common general knowledge in the art.

Various embodiments provide apparatuses and methods for adaptively managing event-related data in a control room.

The following disclosure provides a solution for addressing or mitigating at least one of the above discussed problems. One solution is to use an apparatus to adaptively manage events in a control room by analyzing the spatial (location), time and categorical attribute information (or pre-determined attributes) that are derived from the inputs related to the events. It is to be appreciated that inputs relate to image patterns, audio information, estimated number of a crowd information, density information of a crowd and movement information of a crowd. It will become apparent in subsequent description that the categorical attributes used for analysis in various embodiments are a set of user pre-determined attributes.

Conventionally, the processing, integration, and analysis of spatial (location) data is both constrained and underpinned by the fundamental concept of spatial (location) dependence, resulting in spatial (location) correlation where characteristics at proximal locations tend to be correlated. Spatial (location) dependence is weakened by the heterogeneity and relative degree of uniqueness of the geographical space across locations and thus, such dependence inhibits the use of standard techniques of statistical analysis.

Further, by convention, time has an inherent semantic structure with hierarchical system of granularities. There are two specific aspects of the dimensions of time which have to be taken into account when devising analytical methods for temporal and spatio-temporal data.

First, the temporal dimension which is composed of time points (instant in time) or time intervals (temporal primitive with an extent).

Secondly, the temporal structures such as time in an orderly manner (linear and cyclic time) as well as time in a branching manner and multiple perspectives which is particularly relevant for planning or prediction.

Similar concepts of temporal dependence and temporal correlation exist for relationships in time where observations that are collected closer together in time have a strong likelihood of being more closely correlated to one another.

Typically, large volumes of spatio-temporal data could be collected from diverse application domains such as public safety, transportation, social media, healthcare, and environment. These high dimensional data may be composed of many correlated attributes of numeric, ordinal and categorical values describing various states/properties of places and spatial (location) objects. For example, weather measurement data may include temperature, humidity, amount of rainfall and category (e.g. fine, cloudy, rainy) and demonstrates cyclical pattern over time. However, the complex dependencies, heterogeneity and large volume of multivariate spatio-temporal data makes behavior (patterns and structure) exploration and analysis challenging. Two key considerations include computational efficiency and visual effectiveness problems. Conventional techniques are unable to break down the high volume of data to each component to analyze accurately.

The solution provided in this disclosure addresses these problems by adaptively managing event-related data. In an embodiment, this may include using group partitioning on pre-determined (categorical) attributes and producing alert generation and involves methods of interaction in areas of stream and big data mining for real time monitoring, exploration and analysis, through the following:

An adaptive approach for monitoring and analyzing location-referenced dynamic categorical data given frequency and time of the changes.

An alert generation method to display salient changes to the data in such a way that analysts in a control room can understand the context and relevance of the changes, and reason about their causes and implications in real time by keeping their mental model about the data in sync with the evolving stream.

### Exemplary Embodiments

Embodiments of the present invention will be described, by way of example only, with reference to the drawings. Like reference numerals and characters in the drawings refer to like elements or equivalents.

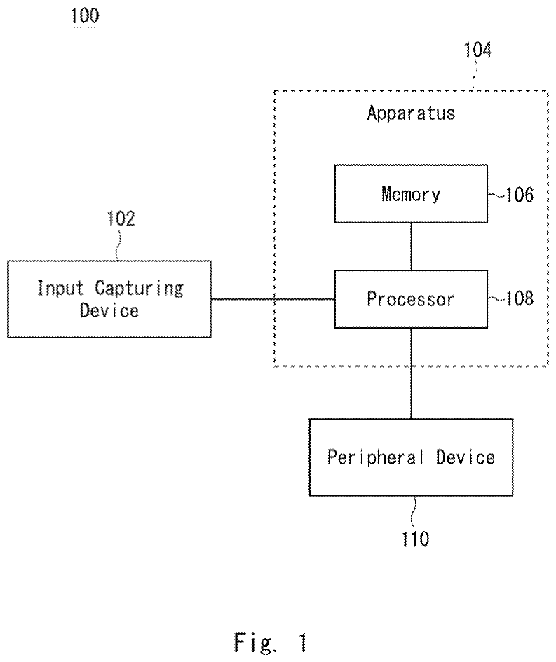

FIG. 1 shows a block diagram illustrating a system 100 for adaptively managing event-related data in a control room according to an embodiment. In an example, the managing of the event-related data is performed by at least an input capturing device 102, an apparatus 104 and a peripheral device 110 to generate or transmit an output. The system may be one that is located within the control room.

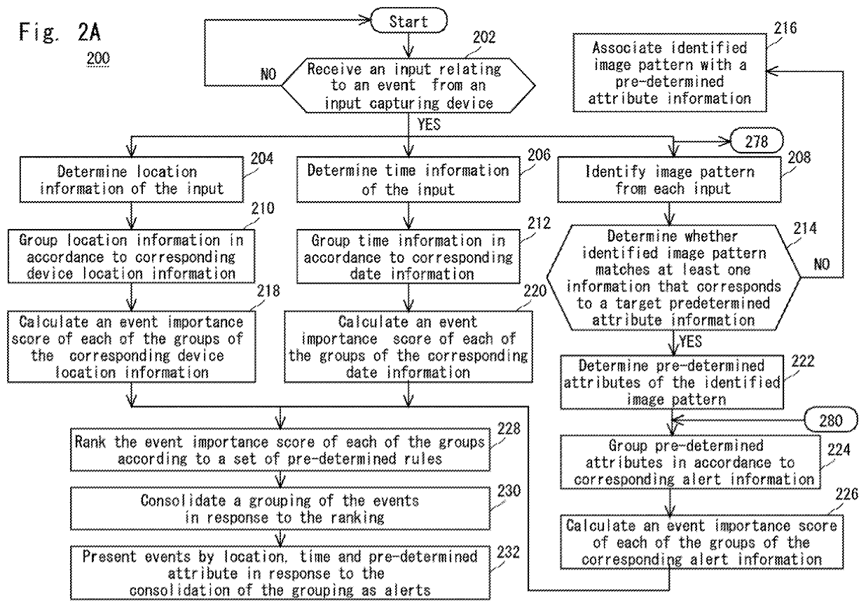

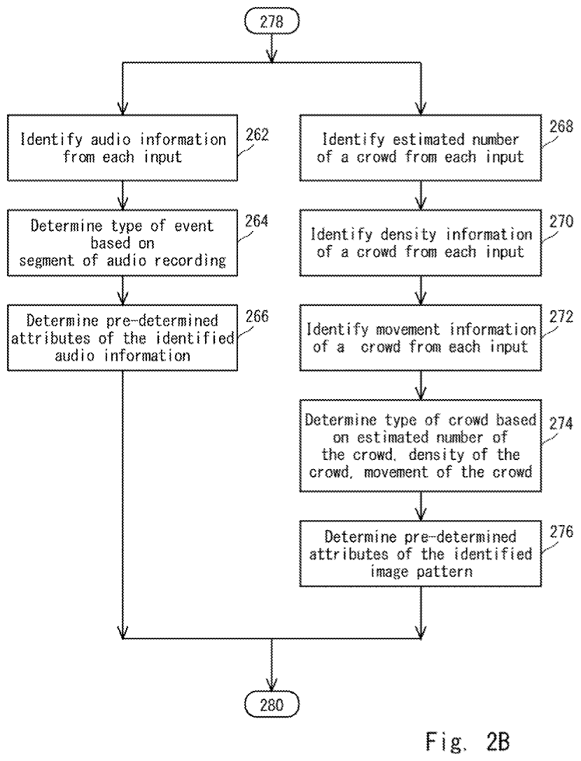

The system 100 comprises an input capturing device 102 in communication with the apparatus 104. In an implementation, the apparatus 104 may be generally described as a physical device comprising at least one processor 108 and at least one memory 106 including computer program code. The at least one memory 106 and the computer program code are configured to, with the at least one processor 108, cause the physical device to perform the operations described in FIGS. 2A and 2B. The processor 108 is configured to receive event-related data from the input capturing device 102 and may also be configured to generate alerts. In various embodiments to be described below, the event-related data may be an input whereby location, time and pre-determined attribute information relating to the event may be derived from the input. A peripheral device 110 in communication with a processor 108 may generate alerts or transmit the alerts generated by processor 108 as output.

In an example, the input capturing device 102 may be one which sends an event-related data. In specific implementations, the input capturing device 102 may include at least one of an input capturing device and location-aware sensor device. The input capturing device 102 may be a device, such as a closed-circuit television (CCTV), a camera on remotely-operated or autonomous unmanned aerial vehicle, or a body-worn camera. The input capturing device 102 provides a variety of spatio-temporal data of which location information, time information and pre-determined attributes that may be derived from the related events. While one input capturing device 102 is shown in FIG. 1, it is to be appreciated that a plurality of input capturing devices 102 may be present.

In an implementation, location information may include at least one of an input capturing device location information such as building, floor, zone and room information; time information may include at least one of a date information such as year, month, week, day, date, hours, minutes information; and pre-determined attributes information may include at least one of an alert information of event categories such as suspicious list (e.g. detecting suspicious persons, abandoned objects, etc.), watch list (e.g. blacklist, whitelist, unknown list, etc.), type of event (e.g. shouting, glass breaking, device tampering, etc.), type of crowd (e.g. crowd gathering, crowd running away, crowd congestion, etc.) or risk level information (e.g. high, medium, low risk). Each of the location information, time information and pre-determined attributes corresponds to a category of information of the data.

In an embodiment, the pre-determined attributes may be a set of user-defined attributes of which the corresponding information of a watch list includes image patterns such as facial information relating to either a blacklist, a whitelist or an unknown list, etc., which is provided by the user and stored in memory 106 or of the apparatus 104 or a database accessible by the apparatus 104. Additionally or alternatively, the pre-determined attributes may be a set of user-defined attributes of which the corresponding information of an event type includes image patterns such as audio sound waves information relating to either a shouting event, glass breaking event or a device tampering event, etc., which is provided by the user. Further, the pre-determined attributes may be a set of user-defined attributes of which the corresponding information of a crowd type includes a number of a crowd information, density information of a crowd, and a movement information of a crowd, etc., which is provided by the user.

The apparatus 104 may be configured to communicate with the input capturing device 102 and the peripheral device 110. In an example, the apparatus 104 may receive, from the input capturing device 102, event-related data and, after processing by the processor 108 in apparatus 104, generate an alert or send an output to the peripheral device 110.

In turn, the peripheral device 110 may be configured to communicate with the apparatus 104 to generate alerts. Additionally or alternatively, the peripheral device 110 may receive, from the processor 108 of the apparatus 104, an output of the processed event-related data and generate alerts as output.

FIG. 2A shows a flow diagram illustrating a method for adaptively managing event-related data in a control room according to an embodiment while FIG. 2B shows a flow diagram illustrating some of the steps of grouping the pre-determined attributes of the inputs according to an embodiment. Location information, time information and pre-determined attribute relating to an event are determined from inputs that are received from the input capturing device and processed to detect changes so as to provide visual correlation and prioritization for faster sensing, analysis and response in a control room. Using conventional techniques, such a visual display of dynamic changes pertaining to an event would not be possible.

Referring to FIGS. 2A and 2B, at step 202, when an input relating to an event is received from an input capturing device 102, one or more of location information, time information and a pre-determined attribute of the input are determined by the processor 108 of the apparatus 104 at steps 204, 206, 222, 266 and 276 respectively in response to the receipt of the input. In an example, the memory 106 and a computer program that is executable by the processor 108 causes the apparatus 104 to organize the input into location information, time information and pre-determined attribute information respectively. In an implementation, (i) the location information may include a building information and a floor information which may also be referred to as device location information; (ii) the time information may include a day information and an hour information which may also be referred to as date information; and (iii) the pre-determined attribute may include an event type information and a risk level information which may also be referred to as an alert information. For example, an event to which an input relates may have occurred at building B-A, floor L2 at 10:05 AM on 6 Jun. 2018 whereby a shouting sound with high risk was detected. Accordingly, the corresponding building information, floor information, day information, hour information, event type and risk level information relating to this event would be determined by the processor 108 as B-A, L2, 6, 10, shouting and high risk respectively.

Prior to step 222, the processor 108 of the apparatus 104 is configured to identify image patterns such as facial information and/or audio information, estimated number of a crowd, density information of a crowd and movement information of a crowd from each input at steps 208, 262, 268, 270 and 272. Subsequently, at step 214, it is determined by the processor 108 whether the identified facial information matches at least one facial information that corresponds to a target pre-determined attribute information. For example, the processor 108 may retrieve a target pre-determined attribute information from a database and compare it to the identified facial information. The target pre-determined attribute may be a facial feature that is specific to the target, for example, a facial mole.

In an example, if the identified facial information does not match any of the facial information of the pre-determined attribute information, the identified facial information may be associated with a pre-determined attribute information such as “unknown” in the watch list which is assigned with a lower weightage at step 216. If however, for example, the identified facial information matches at least one facial information that corresponds to a target pre-determined attribute information such as that of a blacklist in the watch list, the pre-determined attribute of the identified facial information will be determined by the processor 108 as one that may be in a blacklist in step 222.

Other than the identification of image patterns at step 208, audio information is also indentified at step 262. Subsequently, at step 264, it is determined by the processor 108 what is the type of event based on the segment of audio recording of the audio information identified from each input at step 262. Further, at step 274, it is also determined by the processor 108 what is the type of crowd based on the estimated number of the crowd, density of the crowd and movement of the crowd identified from each input at steps 268, 270 and 272 respectively.

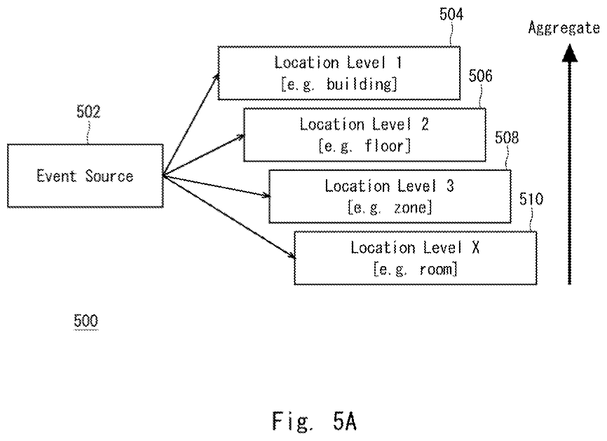

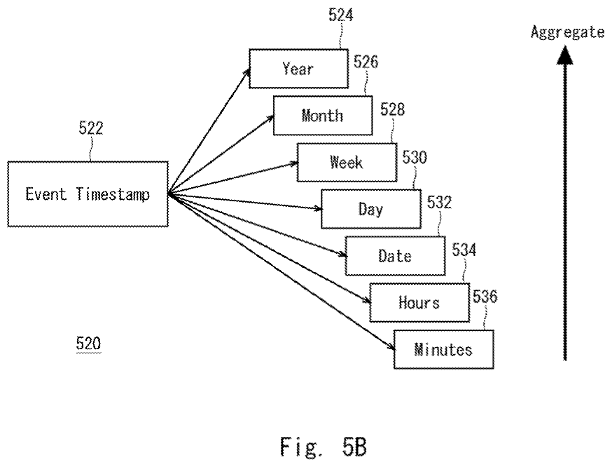

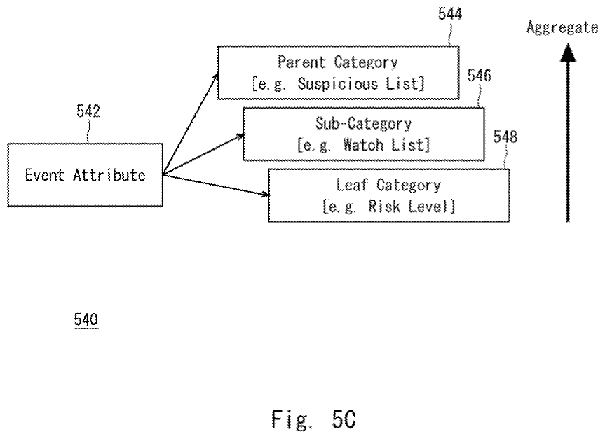

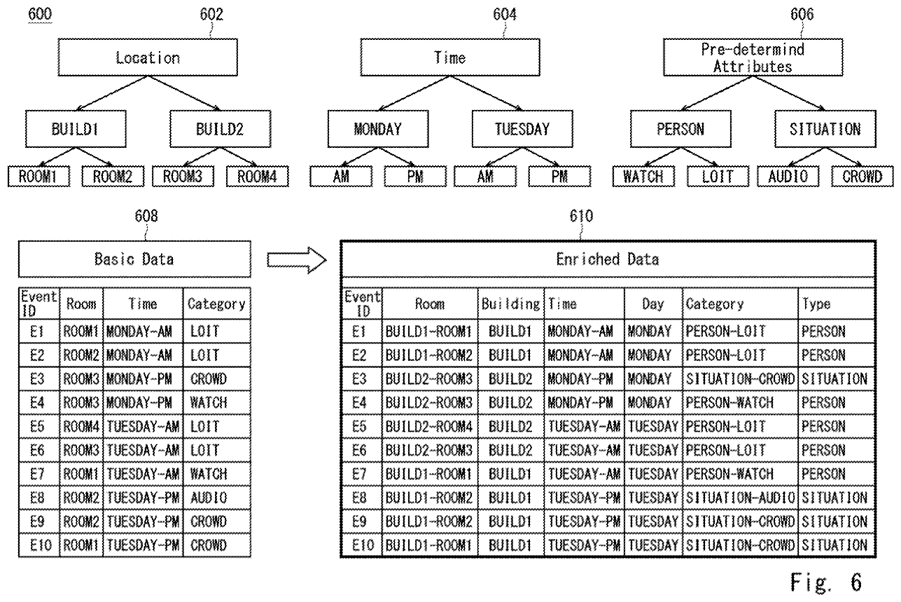

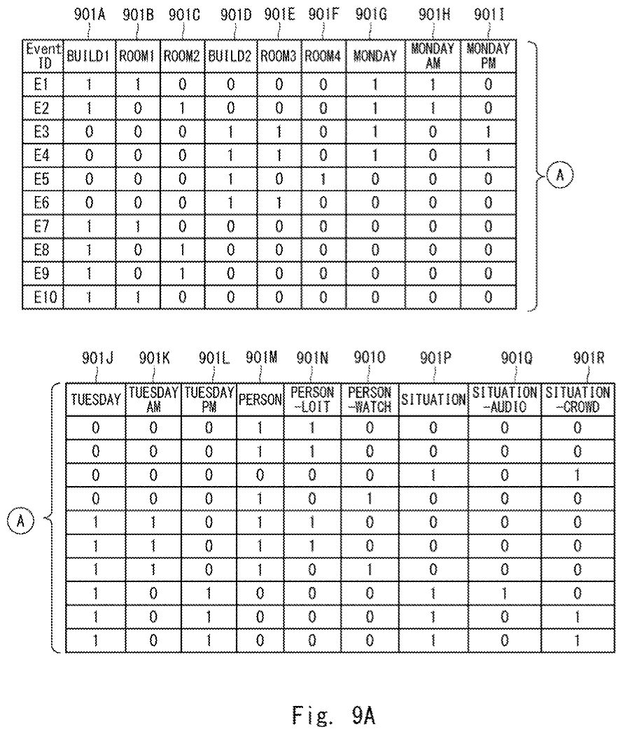

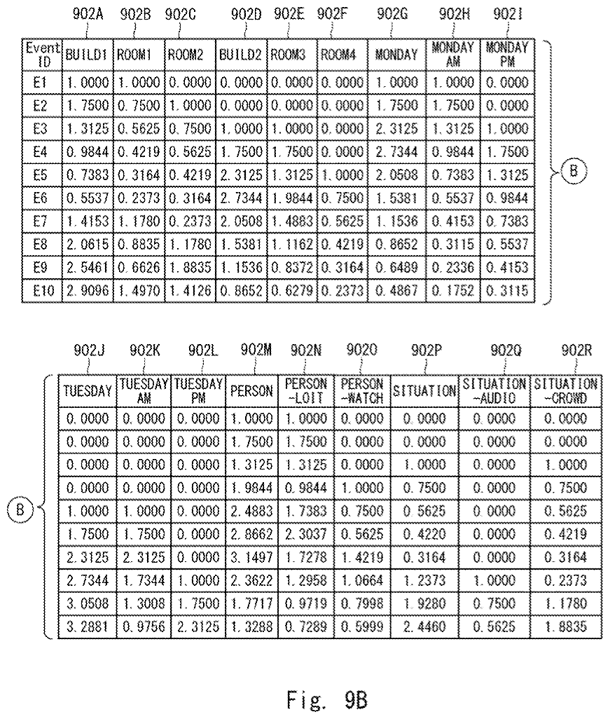

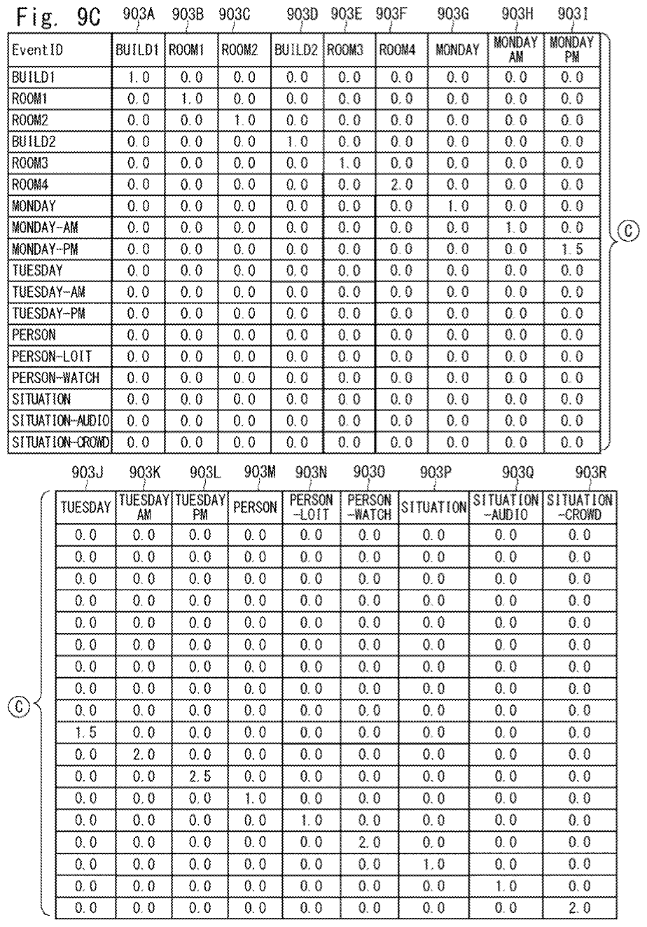

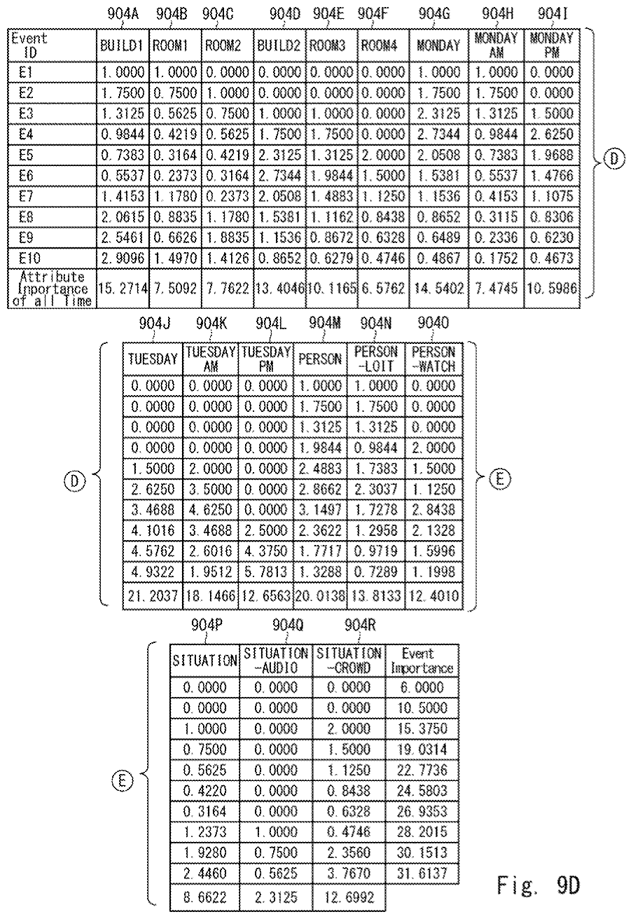

At steps 210, 212 and 224, the method further comprises the steps of grouping the location information, time information or pre-determined attributes respectively in accordance to one of their corresponding building/floor information, day/hour information and event type/risk level information and then calculating an event importance score of each of the groups at steps 218, 220 and 226 respectively. An event importance score is the final importance score that represents the importance of an event by taking into account the custom weights (a user-defined weightage score indicating the importance/priority of an event type) as well as the recency effects (i.e. same type of events happening consecutively will be scored higher). Details regarding how the event importance score is calculated will be shown in FIGS. 9A-9D. More details regarding how location information, time information and pre-determined attributes information may be processed will be shown in FIGS. 5A-5C and FIG. 6 respectively.

The method further comprises step 228 where the event importance score of each of the groups are ranked according to a set of pre-determined rules. In an implementation, the set of pre-determined rules may cause the events to be grouped according to similarity/correlation into representational groups, then an occurrence score of 1 is assigned to every corresponding representational group that represents the event type information that has occurred based on change detection; otherwise, an occurrence score of 0 is assigned. As mentioned earlier, the event importance score takes into account recency effects which is accounted for by a recency score which is one that is calculated based on the occurrence score, with the recency score being higher when there are consecutive occurrences of the same event type. More details regarding the formula of recency score will be discussed below together with FIG. 9B. At the same time, the user-defined weightage score indicating the importance/priority of the event type is also assigned to each of the representational groups and an event importance score is calculated for each of the representational group before the ranking in step 228 is executed. The grouping of the events are then consolidated in response to the ranking in step 230.

To illustrate how the event importance score flags out events of higher importance, take for example, events may be grouped by the same suspicious person detected, at the same location based on event correlation. Then if there is high occurrences of the same suspicious person being detected at the same location, the corresponding recency score will be high. If that particular location happens to have a high weightage score since it is prioritized as an area of interest, the event importance score will be even higher. A representational group with a higher event importance score will be ranked higher than one with a lower event importance score. This allows the high occurrences of a suspicious person detected at the same location of particular interest to be flagged out from the other event types which may have lower occurrences and are not of particular interest to the analyst in the control room.

The processor 108 may generate alerts based on the consolidation of the grouping established in step 230 or send the consolidation of the grouping to the peripheral device 110 which may be configured to generate alerts as output in a control room in response to a receipt of the grouping consolidation information in step 232.

While FIGS. 2A-2B show steps 202 to 232 on how event-related data may be adaptively managed, it should be appreciated that in various embodiments, steps 202, 204, 206, 222, 266, 276 and 232 may be performed to sufficiently adaptively manage event-related data. It should also be appreciated that steps 202 to 232 may be performed in parallel rather than sequentially.

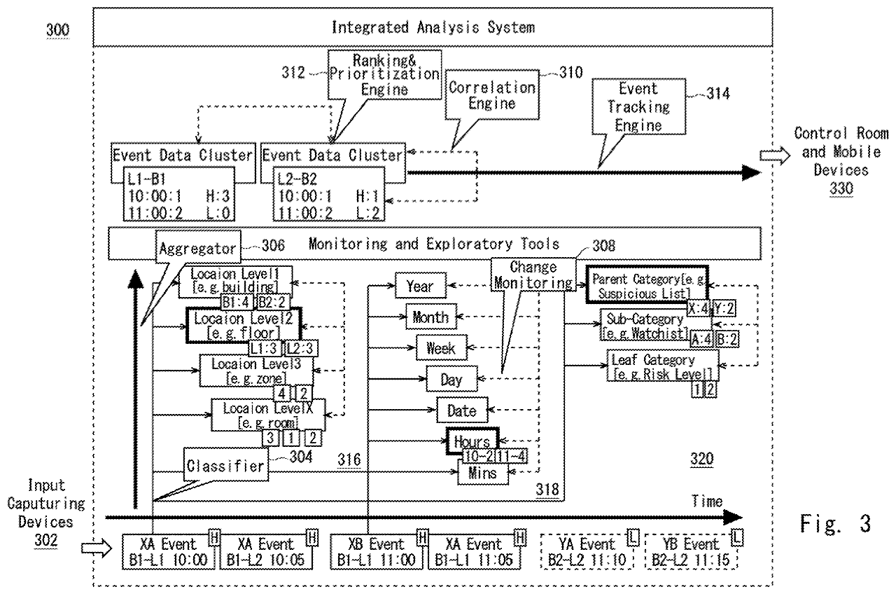

FIG. 3 shows an illustration of system components for adaptively managing event-related data in a control room according to an embodiment. The system 300 is designed to enable faster sensing, analysis and response to abnormal situations. As shown in FIG. 3, the system 300 consists of software modules stored in memory 106 such as a classifier 304, an aggregator 306, a change monitor 308, a correlation engine 310, a ranking and prioritization engine 312 and an event tracking engine 314. The memory 106 and the computer program consisting the software modules 304-314 are executed by the processor 108 to cause the apparatus 104 to perform the processes described below.

As stated earlier, the processor 108 of the apparatus 104 is configured to identify image patterns such as facial information from each input at step 208. After which, the facial information associated with the event-related data from the input capturing devices 302 are assigned to the appropriate event category such as suspicious list (e.g. detecting suspicious persons, abandoned objects, etc.), watch list (e.g. blacklist, whitelist, unknown list, etc.) or risk level (e.g. high, medium, low risk) by the classifier 304 if the identified facial information matches at least one facial information that corresponds to a target pre-determined attribute information as in step 214.

Further, steps 210, 212 and 224 which are the steps of grouping the location information, time information or pre-determined attributes respectively in accordance to one of their corresponding building/floor information, day/hour information and event type/risk level information and the steps of determining an occurrence score of each of the groups at steps 218, 220 and 226 respectively are processed by the aggregator 306.

The change monitor 308 analyzes change and detects unusual anomalous behaviours by tracking both change in value of the occurrence scores and ranking to enhance ranking and prioritization mechanism in step 228.

Event correlation is a technique that relates various events describing or relating to activities in a system to identifiable patterns. It can be defined as a process for consolidating events to increase their information quality, while reducing the quantity of events to provide clear contextual information at a glance. This is processed by the correlation engine 310 at step 228 whereby events are grouped according to similarity/correlation into representational groups.

An analyst's capacity in handling the high velocity, volume and variety of event-related data is limited. Thus, a ranking and prioritization engine 312 to highlight interesting “cluster of events” for further study or exploration is introduced in step 228. “Cluster of events” refers to a group of events with at least one commonality such as a re-occurrence at the same location or a re-appearance of the same target (who could be a loiterer). The ranking mechanism leverages inputs from the change monitor 308 (e.g. the changes in occurrence scores) as one of its key prioritization signals. In an implementation, there is a list of ranking and prioritization rules set by the user which will be run through during the calculation of event importance scores of representational groups by the ranking and prioritization engine 312. For example, the representational groups derived from correlation engine 310 may first have an occurrence score tabulated by the aggregator 306 based on the number of event occurrences. Subsequently, a ranking and prioritization rule may cause the representational groups to have a recency score calculated based on how recent and how frequent the events have occurred. Based on the recency scores and a user-defined weightage scores assigned to each event type, an event importance score is calculated for each representational group and the representational groups are then ranked according to their overall event importance score.

Event tracking engine 314 provides a structured workflow mechanism to process incoming event-related data. Such engine typically provides a way of describing the order of execution and dependent relationships between pieces of short- or long-running work from start to finish to be executed by the system functions.

316, 318 and 320 are software modules that define how location information, time information and pre-determined attribute information may be grouped. An example of how software modules 316, 318 and 320 work, correspond to FIG. 5A, FIG. 5B and FIG. 5C respectively.

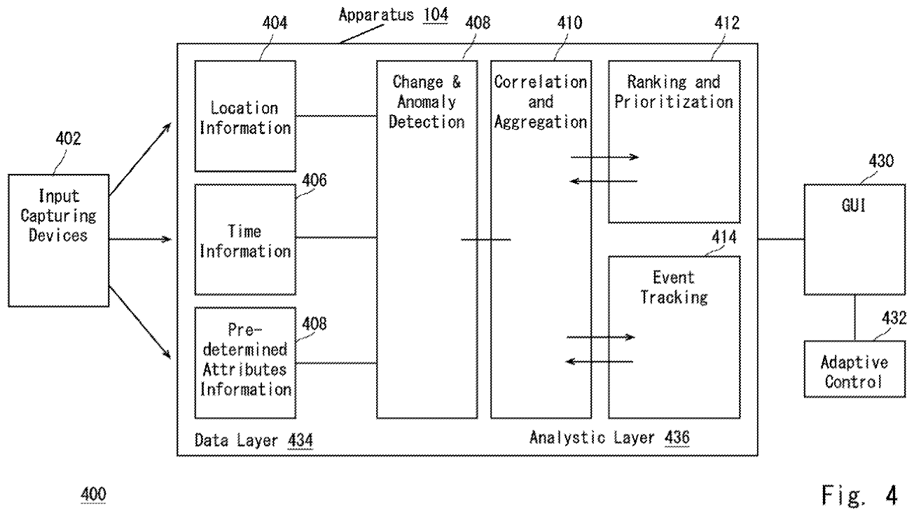

FIG. 4 shows a block diagram illustrating how event-related data may be adaptively managed according to an embodiment. Within the system 400, there is a data layer 434 which consists of location information 404, time information 406 and pre-determined attribute information 408 which may be derived from the inputs received by the input capturing devices 402. There is also an analytics layer 436 which includes:
a change detection 408 module which is configured to function according to the change monitor 308;
a correlation and aggregation 410 module which is configured to function according to the correlation engine 310;
a ranking and prioritization 412 module which is configured to function according to the ranking and prioritization engine 312; and
an event tracking 414 module which is configured to function according to the event tracking engine 314.

In an implementation, there is an adaptive event management solution illustrated in FIG. 4 to reduce the workload of an analyst in a control room which includes:
performing updating on location, time and pre-determined attribute information of incoming real-time stream event-related data in a data layer 434.
performing change detection 408, correlation and aggregation 410 and ranking and prioritization 412 to establish and prioritize events grouping in an Analytics Layer 436.
providing adaptive control 432 and event tracking 414 modules to track and generate alerts for events of interest on the GUI 430.

Simultaneous processing and categorization (grouping) of event-related data received by the input capturing devices in accordance to their corresponding location information, time information and pre-determined attribute information is essential in the method of adaptively managing event-related data in a control room. Many of the existing methods for streaming (real-time) event-related data categorization (grouping) cannot enable on-the-fly separation of event clusters (groups) from the noise and immediate presentation of signification clusters (groups) and their evolution. A multilevel grouping approach is introduced in the adaptive event management method to allow clear and efficient separation of event clusters (groups) and easy tracking and presentation of the evolution of the signification clusters (groups). An example of a multilevel grouping approach is to organise the information in a hierarchical data structure, allowing information to be broken down into smaller granularities. The following illustrations further describe the components of the data layer 434 that store and manage incoming real-time data stream.

As shown in FIG. 5A, a building information 504, floor information 506, zone information 508 and room information 510 (or location information) may be derived from an event source 502. In an implementation, the location information of an incoming event-related data is organised using the multilevel grouping approach whereby the location information is further grouped hierarchically into its building information, floor information, zone information and room information. Using such a structure, it is possible to perform interactive exploration of aggregated location data to track changes and identify patterns of interest.

Further, as shown in FIG. 5B, a year information 524, month information 526, week information 528, day information 530, date information 532, hours information 534 and minutes information 536 may be derived from an event timestamp 522 (or time information). In an implementation, the time information of an incoming event-related data is organised using the multilevel grouping approach whereby the time information is further grouped hierarchically into its year information, month information, week information, day information, date information, hours information and minutes information. Using such a structure, it is possible to perform interactive exploration of aggregated time data to track changes and identify patterns of interest.

As shown in FIG. 5C, a suspicious list information 544, watch list information 546 and risk level information 548 may be derived from an event attribute 542 (or pre-determined attribute). In an implementation, the pre-determined attribute information of an incoming event-related data is organised using the multilevel grouping approach whereby the pre-determined attribute information is further grouped hierarchically into its suspicious list information, watch list information and risk level information. Using such a structure, it is possible to perform multi-modal analytics and interactive exploration of aggregated pre-determined attribute data to track changes and identify patterns of interest.

FIG. 6 illustrates an example of multilevel grouping using hierarchical data structure according to an embodiment. For example, the location information 602 may be grouped into BUILD1 and BUILD2, which can be further grouped into ROOM1, ROOM2 of BUILD1 and ROOM3, ROOM4 of BUILD2 respectively. The time information 604 may be grouped into MONDAY and TUESDAY, which are further grouped into AM, PM of MONDAY and AM, PM of TUESDAY respectively. The pre-determined attribute 606 may be grouped into PERSON and SITUATION, which are further grouped into WATCH, LOIT of PERSON and AUDIO, CROWD of SITUATION respectively.

Basic data 608 shows an example of how event data may be grouped according to a conventional method while enriched data 610 shows an example of how event data may be grouped according to an embodiment which advantageously enhances the representation of the data by providing relationship information of the events within the groups. By various embodiments of the invention, the input may be further processed and represented in various categories like “Location” 602, “Time” 604 and “Pre-determined Attributes” 606.

The analytics layer of an adaptive event management system in an embodiment is further described below. A fundamental capability for real-time analytics in a surveillance system is to analyze change and detect unusual, anomalous behaviours to pick up valuable insights for prompt action and control. Furthermore, in applications that process real-time events, a common requirement is to perform some set-based computation (i.e. aggregation) or other operations over subsets of events that fall within some period of time. The data aggregation provides mechanism to track aggregate data across groupings or multi-levels instead of just based on pure groupings by time only. This process is required by adaptive control to enable interactive query in identifying events that require attention based on specific level of interest. Also, the ranking and prioritization mechanism in an embodiment highlights interesting cluster of events for further study or exploration. This can be accomplished by the recency score where a higher score is derived from a more recent event, and repeated events of a similar type (e.g. higher score for same person detected multiple times within short period of time). Lastly, the event tracking engine in an embodiment provides structured workflow mechanism to handle lifecycle of event-related data from creation until removal.

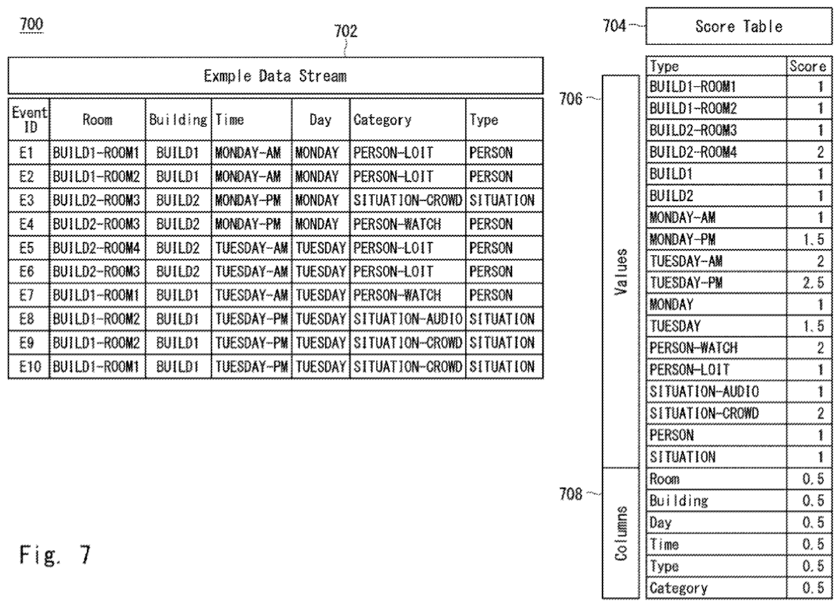

FIG. 7 shows an example of a data stream 702 and an example of a user-defined weightage score table 704 where values 706 of the score table 704 represent the location information of the events such as BUILD1-ROOM1, BUILD1-ROOM2, etc., time information such as MONDAY-AM, MONDAY-PM, etc., and pre-determined attributes such as PERSON-WATCH, SITUATION-CROWD, etc., respectively. The corresponding weightage of the respective values are listed in the score table respectively based on their importance/priority. For example, in this score table 704, additional weightage is allocated to Room 4 in Building 2, Watchlist and Crowd events. Additional weightage can also be allocated to more recent events than past events between Monday AM and Tue PM i.e. from weightage score of 1 to 2.5. Additionally, weightage scores may be allocated to the columns 708 items that represent the representational groups such as Room, Building, Time, Day, Category and Type to denote an order of preference for the column display items in the alert display.

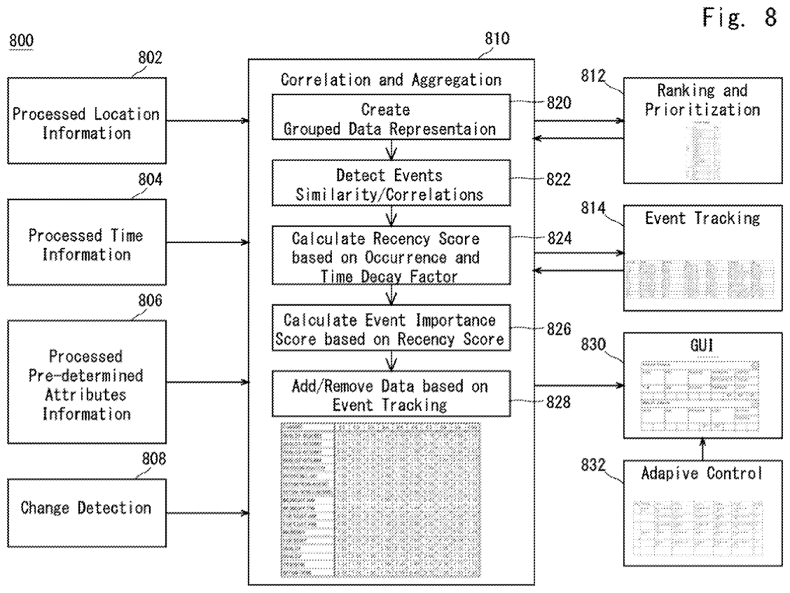

FIG. 8 illustrates an example of how input may be processed in the apparatus in an embodiment. In particular, the change monitor 308 introduced earlier performs change detection 808 based on processed location information 802, processed time information 804 and processed pre-determined attributes information 806. It analyzes changes and detects unusual anomalous behaviours by tracking both change in value and ranking to enhance ranking and prioritization mechanism in step 228. The information then goes through correlation and aggregation 810 whereby grouped data representations 820 are created based on detection of events similarity or correlations 822 and a recency score is calculated based on change detection 824 factoring the occurrence score and time decay factor and an event importance score is calculated based on the recency score and the weightage score allocated to the representational groups 826 (during ranking and prioritization 812). Based on event tracking 814, data is then added or removed in 828 accordingly.

FIGS. 9A, 9B, 9C and 9D illustrate an example of an occurrence matrix, a recency matrix, a score matrix and a final event importance score matrix respectively. FIG. 9A shows an example of how event-related data can be represented for 10 events (shown as E1 to E10) in an occurrence matrix where an occurrence score of 1 is assigned to every corresponding representational group (displayed in each column from 901A to 901R) that represents the event type information that has occurred based on change detection; otherwise, an occurrence score of 0 is assigned. Take for example an event E1 in FIG. 9A whereby a loiterer appears in Building 1 Room 1, on Monday morning. BUILD1 (901A), ROOM1 (901B), MONDAY (901G), MONDAY-AM (901H), PERSON (901M), PERSON-LOIT (901N) will be assigned an occurrence score of 1 while the rest of the columns are assigned an occurrence score of 0. The occurrence matrix does not take into account the sequence of events that happened consecutively. For example, if a chain of events happened in Building 1 Room 1, this should be highlighted.

To take the recency effect of the occurrences into consideration, a recency score is introduced. FIG. 9B shows an example of a recency matrix which is tabulated based on the formula: Recency Score=Time Decay Factor*Recency Score in Previous Step+Occurrence Score (either 1 or 0), where the time decay factor is used to discount the effects of past events. The recency score gives a higher score to the type of events which have also occurred in the past (though a time decay factor is also factored in). Thus, high occurrences of similar events will be flagged out easier as they will be ranked higher.

Take for example event E2 from FIG. 9A whereby a loiterer appears in Building 1 Room 2, on Monday morning. The corresponding representational groups BUILD1 (901A), ROOM2 (901C), MONDAY (901G), MONDAY-AM (901H), PERSON (901M), PERSON-LOIT (901N) will be assigned an occurrence score of 1 while the rest of the columns are assigned an occurrence score of 0. As shown in FIG. 9B, the recency score of BUILD1 (902A) of event E2=0.75*1+1=1.75 where time decay factor is set at 0.75 in the example, recency score in previous step being 1 and occurrence being 1 since the loiterer reappeared at Building 1; the recency score of ROOM1 (902B) of event E2=0.75*1+0=0.75 and ROOM2 (902C) of event E2=0.75*0+1=1 since the loiterer did not reappear in Room 1 but appeared in Room 2 instead. It is evident from this example that in terms of location, Building 1 is ranked the highest with recency score of 1.75 followed by Room 2 at 1 and Room 1 at 0.75. This draws the attention of the analyst to Building 1 which has the highest recency score indicating that there may be a potential security concern at that location and also draws the attention of the analyst next to Room 2 which was where the loiterer was last seen and where the analyst could likely take the next course of action to conduct a search in that region.

FIG. 9C shows an example of a weightage score table 704 in matrix form to facilitate matrix computation in the later step of event importance score calculation. The diagonal matrix has diagonal elements representing the weightage scores assigned to each event type defined by the users. As seen from the score matrix, additional weightage is allocated to Room 4 [ROOM4 (903F)], Watchlist [PERSON-WATCH (9030)] and Crowd [SITUATION-CROWD (903R)] events; additional weightage can also be allocated to more recent events than past events between Monday AM (903H) and Tue PM (903L) i.e. from weightage score of 1 to 2.5.

FIG. 9D shows an example of an event importance matrix for 10 events (shown as E1 to E10) obtained by performing matrix multiplication between the recency matrix in FIG. 9B and the weightage score matrix in FIG. 9C, whereby Event Importance Score (904T)=Recency Score*Weightage Score. Take for example, ROOM4 (904F) of event E6 with recency score of 0.75 and corresponding weightage score of 2, the event importance score=0.75*2=1.5 as seen in FIG. 9D. The event importance score represents the importance of an event by taking into account the custom weights as well as the recency effect (i.e. sequence of same type of events happening consecutively having higher importance).

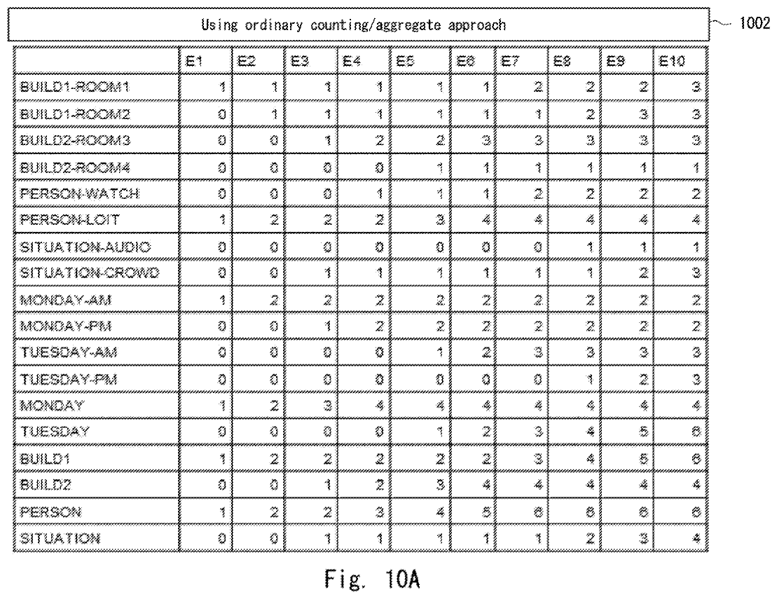

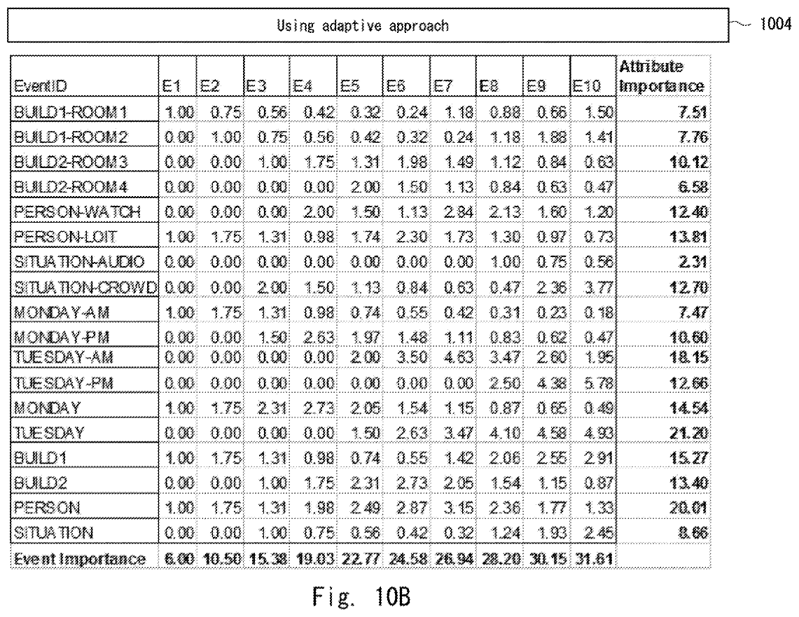

FIGS. 10A and 10B show an example of an event importance score matrix in comparison to a conventional score matrix whereby 1002 shows the conventional score matrix using ordinary counting or aggregation approach and the events are difficult to prioritize because of the similar total counts while 1004 shows the event importance score matrix using adaptive approach whereby prioritization of the events is made possible because of the different graded output scores. For example, referring to the same event E1 as above whereby a loiterer appears in Building 1 Room 1, on Monday morning and the same event E2 whereby a loiterer appears in Building 1 Room 2, on Monday morning, the aggregated score for BUILD1-ROOM1 calculated using ordinary counting or aggregation approach (1002) for E1 is 1 since there was 1 event occurrence at Building 1 Room 1. Subsequently, the aggregated score for BUILD1-ROOM1 for E2 is also 1 (1+0=1) since there was 0 event occurrence at Building 1 Room 1 for E2. However, using the adaptive approach (1004), event importance score for BUILD1-ROOM1 for E1=1 but the event importance score for BUILD1-ROOM1 for E2=0.75*1+0=0.75 as explained above for ROOM1 (902B) and wherein the weightage score for BUILD1-ROOM1 is 1. In this way, it is evident that the scores derived from the adaptive approach 1004 is graded and prioritization of the events is made possible unlike the scores derived from ordinary counting or aggregation approach 1002.

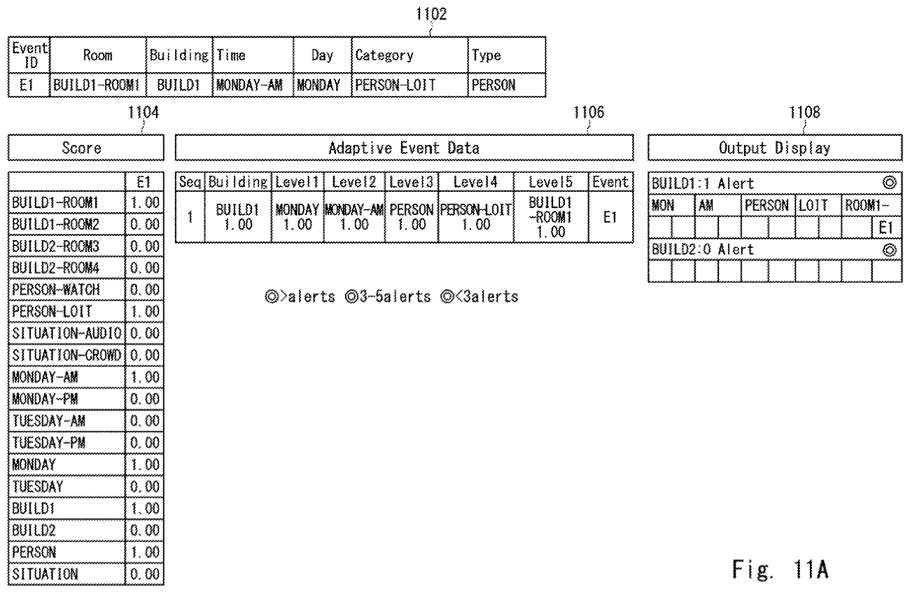

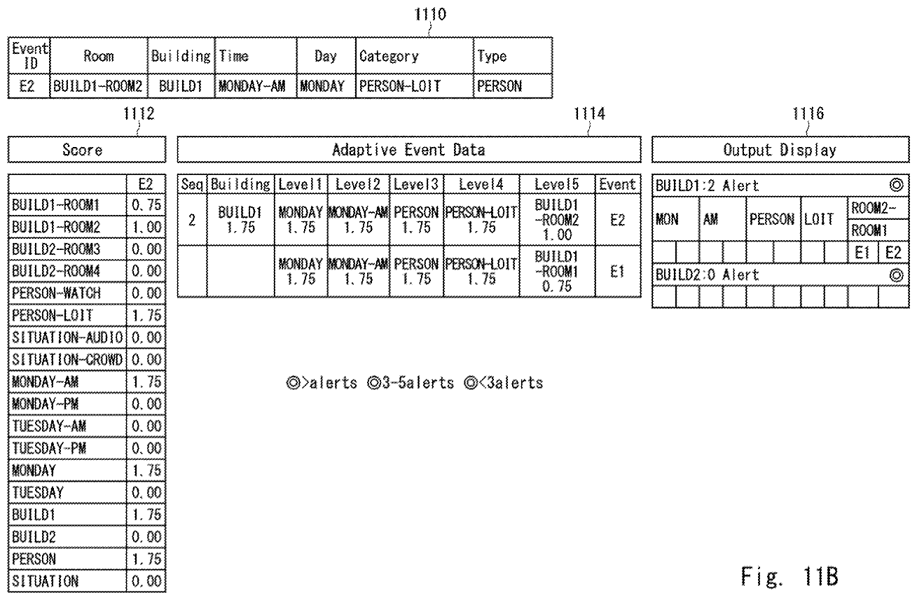

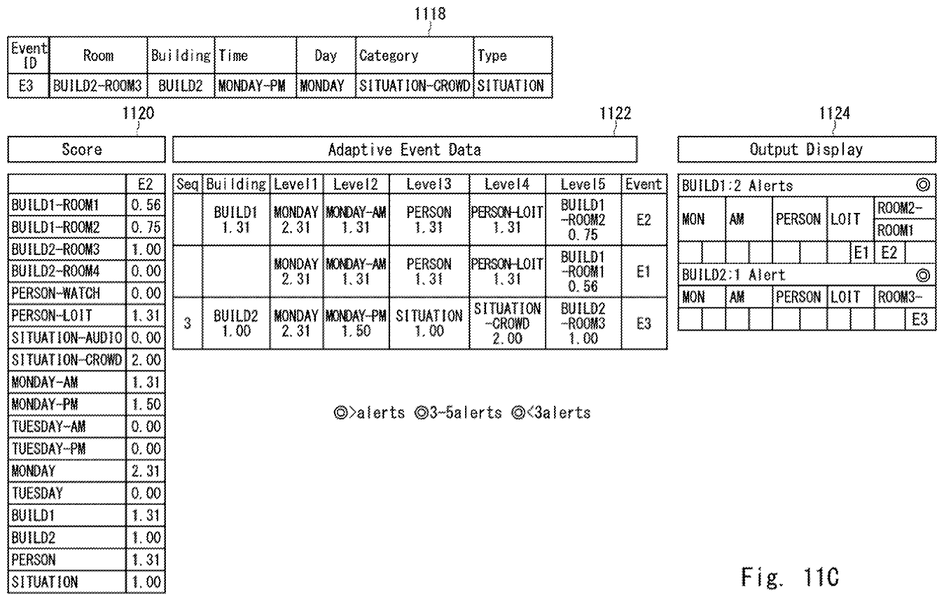

FIGS. 11A, 11B and 11C show examples of how events are handled using a method for adaptively managing event-related data in a control room according to an embodiment. 1102 represents event-related data of event E1 whereby a loiterer appears in Building 1 Room 1, on Monday morning. 1104 represents a table of the updated event importance scores of every representational group upon re-calculation of the recency scores and event importance scores after every event occurrence, where the display level is prioritized based on the event importance score while 1106 represents the adaptive event data which are the corresponding event importance scores of the respective representational groups, updated after every event. In these examples, the adaptive control is set to “Building” and thus, the output display 1108 is consolidated by the “Building” information i.e. number of alerts are consolidated by BUILD1 and BUILD2.

For example, to determine the levels (take for example Level 1 to Level 5 in 1106) to group the event types:
1. “Building” is set to be the first attribute to group the alerts.
2. To determine Level 1:
   For all events that happened in the same building, find the parent-child attributes (i.e. Day-Time, Building-Room, Category-Type) that has the highest score.
   Use the parent attribute if it has not been used yet, otherwise use the child attribute as level 1.
3. To determine Level 2:
   For all events that happened in the same building and have the same Level 1, find the remaining unused parent-child attributes (i.e. Day-Time, Building-Room, Category-Type) that has the highest score.
   Use the parent attribute if it has not been used yet, otherwise use the child attribute as level 1
4. Similar calculation for Level 3, 4 and 5.

A time decay factor of 0.75 and weightage scores as indicated in score table 704 are used in the following examples. In FIG. 11A, since this is the first event E1, the corresponding event importance score of the representational groups related to a loiterer appearing in Building 1 Room 1, on Monday morning are all 1 since occurrence score is 1, recency score is 0.75*0+1=1 and the weightage scores of each of the representational groups are 1; i.e. corresponding event important scores of BUILD1-ROOM1, BUILD1, MONDAY-AM, MONDAY, PERSON-LOIT and PERSON as shown in Seq 1 of adaptive event data 1106 and as shown in event importance score table 1104 are each updated to a score of 1 respectively while the other representational groups that do not relate to event E1 remain at a score of 0. The output display 1108 will show “1 Alert” in BUILD1 with a green icon indicating <3 alerts together with the related representation groups information in response to the detection of the first event E1.

FIG. 11B shows an example when a second event E2 occurs, with the event-related data as shown in 1110 whereby a loiterer appears in Building 1 Room 2, on Monday morning. In particular, it can be observed that while BUILD1, MONDAY-AM, MONDAY, PERSON-LOIT and PERSON have similar occurrence and recency scores (and thus, similar event importance scores), BUILD-ROOM2 and BUILD-ROOM1 will have differing event importance scores as events E2 and E1 differ in room location information. With the occurrence of event E2, for BUILD-ROOM1, the current occurrence score is 0, past recency score is 1, causing the updated recency score to be 0.75*1+0=0.75 which results in an event importance score of 0.75 (since weightage score is 1). On the other hand, representational group BUILD-ROOM2 has an occurrence score of 1, past recency score of 0, causing the updated recency score to be 0.75*0+1=1=event importance score (since weightage score is 1). The other representational groups BUILD1, MONDAY-AM, MONDAY, PERSON-LOIT and PERSON each with an occurrence score of 1, past recency score of 1, will have an updated recency score of 0.75*1+1=1.75=event importance score (since weightage score is 1). The corresponding event important scores of BUILD1, MONDAY-AM, MONDAY, PERSON-LOIT and PERSON as shown in Seq 2 of adaptive event data 1114 and as shown in event importance score table 1112 are each updated to a score of 1.75 respectively while BUILD1-ROOM1 is updated to a score of 0.75, BUILD-ROOM2 is updated to a score of 1 and the other representational groups that do not relate to either event E1 or E2 remain at a score of 0. The output display 1116 will show “2 Alerts” in BUILD1 with a green icon indicating <3 alerts together with the related representation groups information in response to the detection of the second event E2.

FIG. 11C shows an example when a third event E3 occurs, with the event-related data as shown in 1118 whereby a crowd situation happens in Building 2 Room 3, on Monday afternoon. In particular, it can be observed that only the representational group MONDAY is common among the three events E1-E3. With the occurrence of event E3, for MONDAY, the occurrence score is 1, past recency score is 1.75, causing the updated recency score to be 0.75*1.75+1=2.3=event importance score (since weightage score is 1). The other first-occurring representational groups such as BUILD2, BUILD2-ROOM3 and SITUATION each have an event importance score of 1 (as explained in FIG. 11A) while MONDAY-PM and SITUATION-CROWD have an event importance score of 1.5 and 2 respectively, due to a difference weightage score of 1.5 and 2 respectively. Remaining representational groups such as BUILD1, MONDAY-AM, PERSON-LOIT and PERSON are updated accordingly based on the current occurrence score of 0, past recency score of 1.75, the updated recency score will be 0.75*1.75+0=1.3=event importance score (since weightage score is 1). It should be apparent that the event importance scores of the remaining representational groups will also be updated accordingly based on the same calculation methods as disclosed above. Accordingly, the output display 1124 will be updated to “1 Alert” in BUILD2 with a green icon indicating <3 alerts together with the related representation groups information in response to the detection of the third event E3.

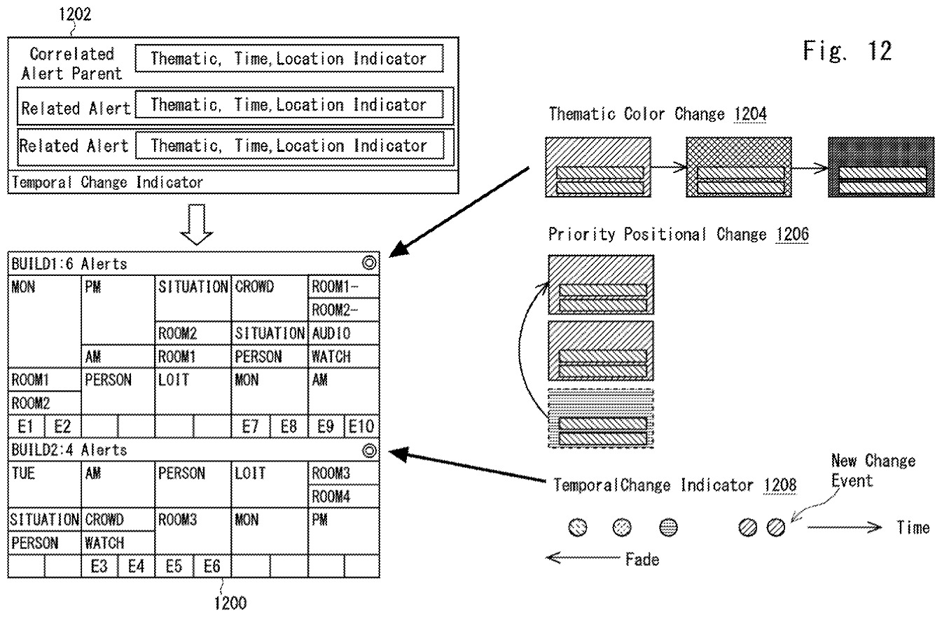

FIG. 12 illustrates an example of how alerts relating to events may be presented according to an embodiment. The visualization may be presented as on indicator icons, animated movement in color as well as display position to highlight event of interest for further investigation. In an example, alerts that are generated may be presented as multiple related alerts, headed with a correlated alert parent, with each alert having a corresponding thematic, time and location indicator as in 1202. The alert parent may indicate “BUILD1: 6 Alerts” with the respective multiple related alerts indicating the other event-related information such as day-time, type-category, and room information that are of high priority. Example of thematic color change is shown as in 1204 and positional changes may be used to present priority changes as in 1206 to allow an analyst in a control room to know what has happened immediately and which event to focus on, with co-related event details provided all at one glance. Animated time change indicator 1208 as shown also allows an analyst to detect event changes immediately.

Unless specifically stated otherwise, and as apparent from the following, it will be appreciated that throughout the present specification, discussions utilizing terms such as “scanning”, “calculating”, “analyzing”, “determining”, “replacing”, “generating”, “initializing”, “outputting”, “receiving”, “retrieving”, “identifying”, “predicting” or the like, refer to the action and processes of a computer system, or similar electronic device, that manipulates and transforms data represented as physical quantities within the computer system into other data similarly represented as physical quantities within the computer system or other information storage, transmission or display devices.

It will be appreciated by a person skilled in the art that numerous variations and/or modifications may be made to the present invention as shown in the specific embodiments without departing from the spirit or scope of the invention as broadly described. For example, the above description mainly presenting alerts on a visual interface, but it will be appreciated that another type of alert presentation, such as sound alert, can be used in alternate embodiments to implement the method. Some modifications, e.g. adding an access point, changing the log-in routine, etc., may be considered and incorporated. The present embodiments are, therefore, to be considered in all respects to be illustrative and not restrictive.

For example, the whole or part of the exemplary embodiments disclosed above can be described as, but not limited to, the following supplementary notes.

(Supplementary Note 1)

A method for adaptively managing events in a control room, comprising:
receiving, from an input capturing device, an input relating to an event;
determining a location information and a time information in response to the receipt of the input;
determining a pre-determined attribute of the input, the pre-determined attribute determining at least a type of the event; and
determining a presentation of the event in response to the determination of the location information, the time information and the pre-determined attribute of the input.

(Supplementary Note 2)

The method of note 1, further comprising:
receiving, from a plurality of input capturing devices, a plurality of inputs, each of the plurality of inputs relating to at least one event;
   determining a plurality of location information and a plurality of time information in response to the receipt of the plurality of inputs, each of the plurality of location information and the plurality of time information corresponding to one of the plurality of the inputs;
   determining a plurality of pre-determined attributes of the plurality of inputs, each of the plurality of pre-determined attributes determining at least a type of the at least one event; and
   determining a plurality of presentation of the one or more events in response to the determination of the plurality of location information, the plurality of time information and the plurality of pre-determined attribute of the plurality of inputs.

(Supplementary Note 3)

The method of note 2, wherein each of the plurality of location information has a corresponding at least one of a device location information, including a building information or a floor information, and wherein the step of determining location information in response to the receipt of the inputs comprises:
grouping the plurality of location information into at least one group in accordance to its corresponding device location information.

(Supplementary Note 4)

The method of note 2, wherein each of the plurality of time information has a corresponding at least one of a date information, including a day information or an hour information, and wherein the step of determining time information in response to the receipt of the inputs comprises:
grouping the plurality of time information into at least one group in accordance to its corresponding date information.

(Supplementary Note 5)

The method of note 2, wherein each of the plurality of pre-determined attributes has a corresponding at least one of an alert information, including an event type information or a risk level information, and wherein the step of determining pre-determined attributes in response to the receipt of the inputs comprises:
grouping the plurality of pre-determined attributes into at least one group in accordance to its corresponding alert information.

(Supplementary Note 6)

The method of note 3, wherein the step of determining location information in response to the receipt of the inputs comprises:
calculating an event importance score based on a corresponding weightage allocated to each device location information and a recency value at a point in time, the event importance score relating to an indication of importance of the event and the recency value indicating how recent the inputs are received.

(Supplementary Note 7)

The method of note 4, wherein the step of determining time information in response to the receipt of the inputs comprises:
calculating an event importance score based on a corresponding weightage allocated to each date information and a recency value at a point in time, the event importance score relating to an indication of importance of the event and the recency value indicating how recent the inputs are received.

(Supplementary Note 8)

The method of note 5, wherein the step of determining pre-determined attributes in response to the receipt of the inputs comprises:
calculating an event importance score based on a corresponding weightage allocated to each alert information and a recency value at a point in time, the event importance score relating to an indication of importance of the event and the recency value indicating how recent the inputs are received.

(Supplementary Note 9)

The method of note 5, wherein the step of grouping the pre-determined attributes of the inputs comprises:
identifying at least one of an image pattern from each of the plurality of inputs relating to the at least one event;
determining if the identified image pattern matches at least one information that corresponds to a target pre-determined attribute information prior to grouping the pre-determined attribute of the input; wherein the method further comprises:
associating the identified image pattern with a pre-determined attribute information if the identified information does not match at least one information that corresponds to a target pre-determined attribute information.

(Supplementary Note 10)

The method of note 5, wherein the step of grouping the pre-determined attributes of the inputs comprises:
identifying at least one of an audio information from each of the plurality of inputs relating to the at least one event;
determining a type of event based on a segment of audio recording prior to grouping the pre-determined attribute of the input.

(Supplementary Note 11)

The method of note 5, wherein the step of grouping the pre-determined attributes of the inputs comprises:
identifying at least one of an estimated number of a crowd information from each of the plurality of inputs relating to the at least one event;
identifying at least one of a density information of the crowd information from each of the plurality of inputs relating to the at least one event;
identifying at least one of a movement information of the crowd information from each of the plurality of inputs relating to the at least one event;
determining at least one of a type of the crowd information based on the estimated number of a crowd information, a density information and a movement information prior to grouping the pre-determined attribute of the input.

(Supplementary Note 12)

The method of any one of notes 6, 7, 8, wherein the step of determining the presentation of the input in response to the event comprises:
ranking the event importance score of the at least one group of location information, date information or pre-determined attribute information according to a set of pre-determined rules;
consolidating a grouping of the events based on their corresponding location information, time information and pre-determined attribute information in response to the ranking; and
presenting the events by their location, time and pre-determined attribute in response to the consolidation of the grouping, as alerts in the control room.

(Supplementary Note 13)

An apparatus for adaptively managing events in a control room, the apparatus comprising:
a memory in communication with a processor, the memory storing a computer program recorded therein, the computer program being executable by the processor to cause the apparatus at least to:
receive, from a plurality of input capturing devices, a plurality of inputs, each of the plurality of inputs relating to at least one event;
determine a plurality of location information and a plurality of time information in response to the receipt of the plurality of inputs, each of the plurality of location information and the plurality of time information corresponding to one of the plurality of the inputs;
   determine a plurality of pre-determined attributes of the plurality of inputs, each of the plurality of pre-determined attributes determining at least a type of the at least one event; and
   determine a plurality of presentation of the one or more events in response to the determination of the plurality of location information, the plurality of time information and the plurality of pre-determined attribute of the plurality of inputs.

(Supplementary Note 14)

The apparatus of note 13, wherein each of the plurality of location information has a corresponding at least one of a device location information, including a building information or a floor information and wherein the memory and the computer program is executed by the processor to cause the apparatus further to:
group the plurality of location information into at least one group in accordance to its corresponding device location information in response to the receipt of the inputs.

(Supplementary Note 15)

The apparatus of note 13, wherein each of the plurality of time information has a corresponding at least one of a date information, including a day information or an hour information and wherein the memory and the computer program is executed by the processor to cause the apparatus further to:
group the plurality of time information into at least one group in accordance to its corresponding date information in response to the receipt of the inputs.

(Supplementary Note 16)

The apparatus of note 13, wherein each of the plurality of pre-determined attributes has a corresponding at least one of an alert information, including an alert type information or a risk level information, and wherein the memory and the computer program is executed by the processor to cause the apparatus further to:
group the plurality of pre-determined attributes into at least one group in accordance to its corresponding alert information in response to the receipt of the inputs.

(Supplementary Note 17)

The apparatus of note 14, wherein the memory and the computer program is executed by the processor to cause the apparatus further to:
calculate an event importance score based on a corresponding weightage allocated to each device location information and a recency value at a point in time, the event importance score relating to an indication of importance of the event and the recency value indicating how recent the inputs are received.

(Supplementary Note 18)

The apparatus of note 15, wherein the memory and the computer program is executed by the processor to cause the apparatus further to:
calculate an event importance score based on a corresponding weightage allocated to each date information and a recency value at a point in time, the event importance score relating to an indication of importance of the event and the recency value indicating how recent the inputs are received.

(Supplementary Note 19)

The apparatus of note 16, wherein the memory and the computer program is executed by the processor to cause the apparatus further to:
calculate an event importance score based on a corresponding weightage allocated to each alert information and a recency value at a point in time, the event importance score relating to an indication of importance of the event and the recency value relating to how recent the inputs are received.

(Supplementary Note 20)

The apparatus of note 16, wherein the memory and the computer program is executed by the processor to cause the apparatus further to:
identify at least one of an image pattern from each of the plurality of inputs relating to the at least one event;
determine if the identified facial or object information matches at least one information that corresponds to a target pre-determined attribute information prior to grouping the pre-determined attribute of the input; and
associate the identified image pattern with a pre-determined attribute information if the identified information does not match at least one information that corresponds to a target pre-determined attribute information.

(Supplementary Note 21)

The apparatus of note 16, wherein the memory and the computer program is executed by the processor to cause the apparatus further to:
identify at least one of an audio information from each of the plurality of inputs relating to the at least one event;
determine a type of event based on a segment of audio recording prior to grouping the pre-determined attribute of the input.

(Supplementary Note 22)

The apparatus of note 16, wherein the memory and the computer program is executed by the processor to cause the apparatus further to:
identify at least one of an estimated number of a crowd information from each of the plurality of inputs relating to the at least one event;
identify at least one of a density information of the crowd information from each of the plurality of inputs relating to the at least one event;
identify at least one of a movement information of the crowd information from each of the plurality of inputs relating to the at least one event;
determine at least one of a type of the crowd information based on the estimated number of a crowd information, a density information and a movement information prior to grouping the pre-determined attribute of the input.

(Supplementary Note 23)

The apparatus of any one of notes 17, 18 or 19, wherein the memory and the computer program is executed by the processor to cause the apparatus further to:
rank the event importance score of the at least one group of location information, date information or pre-determined attribute information according to a set of pre-determined rules;
consolidate a grouping of the events based on their corresponding location information, time information and pre-determined attribute information in response to the ranking; and present the events by their location, time and pre-determined attribute in response to the consolidation of the grouping, as alerts in the control room.

(Supplementary Note 24)

A system for adaptively managing events, the system comprising:
the apparatus as claimed in any one of notes 13-23 and at least one of an input capturing device and a peripheral device in communication with the processor, wherein the peripheral device is configured to generate alerts in the control room.

This application is based upon and claims the benefit of priority from Singapore Patent Application No. 10201807628X, filed on Sep. 5, 2018, the disclosure of which is incorporated herein in its entirety by reference.

### REFERENCE SIGNS LIST

100 System
102 Input Capturing Device
104 Apparatus
106 Memory
108 Processor
110 Peripheral Device
400 System
402 Input Capturing Device
404 Location Information
406 Time Information
408 Pre-determined Attribute Information
410 Correlation and Aggregation
412 Ranking and Prioritization
414 Event Tracking
430 GUI
432 Adaptive Control

What is claimed is:

1. A method for adaptively managing events in a control room, comprising:
receiving, from an input capturing device, an input relating to an event;
determining a location information and a time information in response to the receipt of the input;
determining a pre-determined attribute of the input, the pre-determined attribute determining at least a type of the event; and
determining a presentation of the event in response to the determination of the location information, the time information and the pre-determined attribute of the input.

2. The method of claim 1, further comprising:
receiving, from a plurality of input capturing devices, a plurality of inputs, each of the plurality of inputs relating to at least one event;
determining a plurality of location information and a plurality of time information in response to the receipt of the plurality of inputs, each of the plurality of location information and the plurality of time information corresponding to one of the plurality of the inputs;
determining a plurality of pre-determined attributes of the plurality of inputs, each of the plurality of pre-determined attributes determining at least a type of the at least one event; and
determining a plurality of presentation of the one or more events in response to the determination of the plurality of location information, the plurality of time information and the plurality of pre-determined attribute of the plurality of inputs.

3. The method of claim 2, wherein each of the plurality of location information has a corresponding at least one of a device location information, including a building information or a floor information, and wherein the step of determining location information in response to the receipt of the inputs comprises:
grouping the plurality of location information into at least one group in accordance to its corresponding device location information.

4. The method of claim 2, wherein each of the plurality of time information has a corresponding at least one of a date information, including a day information or an hour information, and wherein the step of determining time information in response to the receipt of the inputs comprises:
grouping the plurality of time information into at least one group in accordance to its corresponding date information.

5. The method of claim 2, wherein each of the plurality of pre-determined attributes has a corresponding at least one of an alert information, including an event type information or a risk level information, and wherein the step of determining pre-determined attributes in response to the receipt of the inputs comprises:
grouping the plurality of pre-determined attributes into at least one group in accordance to its corresponding alert information.

6. The method of claim 3, wherein the step of determining location information in response to the receipt of the inputs comprises:
calculating an event importance score based on a corresponding weightage allocated to each device location information and a recency value at a point in time, the event importance score relating to an indication of importance of the event and the recency value indicating how recent the inputs are received.

7. The method of claim 4, wherein the step of determining time information in response to the receipt of the inputs comprises:
calculating an event importance score based on a corresponding weightage allocated to each date information and a recency value at a point in time, the event importance score relating to an indication of importance of the event and the recency value indicating how recent the inputs are received.

8. The method of claim 5, wherein the step of determining pre-determined attributes in response to the receipt of the inputs comprises:
calculating an event importance score based on a corresponding weightage allocated to each alert information and a recency value at a point in time, the event importance score relating to an indication of importance of the event and the recency value indicating how recent the inputs are received.

9. The method of claim 5, wherein the step of grouping the pre-determined attributes of the inputs comprises:
identifying at least one of an image pattern from each of the plurality of inputs relating to the at least one event;
determining if the identified image pattern matches at least one information that corresponds to a target pre-determined attribute information prior to grouping the pre-determined attribute of the input; wherein the method further comprises:
associating the identified image pattern with a pre-determined attribute information if the identified information does not match at least one information that corresponds to a target pre-determined attribute information.

10-11. (canceled)

12. The method of claim 6, wherein the step of determining the presentation of the input in response to the event comprises:
ranking the event importance score of the at least one group of location information, date information or pre-determined attribute information according to a set of pre-determined rules;
consolidating a grouping of the events based on their corresponding location information, time information and pre-determined attribute information in response to the ranking; and
presenting the events by their location, time and pre-determined attribute in response to the consolidation of the grouping, as alerts in the control room.

13. An apparatus for adaptively managing events in a control room, the apparatus comprising:
a memory in communication with a processor, the memory storing a computer program recorded therein, the computer program being executable by the processor to cause the apparatus at least to:
receive, from a plurality of input capturing devices, a plurality of inputs, each of the plurality of inputs relating to at least one event;
determine a plurality of location information and a plurality of time information in response to the receipt of the plurality of inputs, each of the plurality of location information and the plurality of time information corresponding to one of the plurality of the inputs;
determine a plurality of pre-determined attributes of the plurality of inputs, each of the plurality of pre-determined attributes determining at least a type of the at least one event; and
determine a plurality of presentation of the one or more events in response to the determination of the plurality of location information, the plurality of time information and the plurality of pre-determined attribute of the plurality of inputs.

14. The apparatus of claim 13, wherein each of the plurality of location information has a corresponding at least one of a device location information, including a building information or a floor information and wherein the memory and the computer program is executed by the processor to cause the apparatus further to:
group the plurality of location information into at least one group in accordance to its corresponding device location information in response to the receipt of the inputs.

15. The apparatus of claim 13, wherein each of the plurality of time information has a corresponding at least one of a date information, including a day information or an hour information and wherein the memory and the computer program is executed by the processor to cause the apparatus further to:
group the plurality of time information into at least one group in accordance to its corresponding date information in response to the receipt of the inputs.

16. The apparatus of claim 13, wherein each of the plurality of pre-determined attributes has a corresponding at least one of an alert information, including an alert type information or a risk level information, and wherein the memory and the computer program is executed by the processor to cause the apparatus further to:
group the plurality of pre-determined attributes into at least one group in accordance to its corresponding alert information in response to the receipt of the inputs.

17. The apparatus of claim 14, wherein the memory and the computer program is executed by the processor to cause the apparatus further to:
calculate an event importance score based on a corresponding weightage allocated to each device location information and a recency value at a point in time, the event importance score relating to an indication of importance of the event and the recency value indicating how recent the inputs are received.

18. The apparatus of claim 15, wherein the memory and the computer program is executed by the processor to cause the apparatus further to:
calculate an event importance score based on a corresponding weightage allocated to each date information and a recency value at a point in time, the event importance score relating to an indication of importance of the event and the recency value indicating how recent the inputs are received.

19. The apparatus of claim 16, wherein the memory and the computer program is executed by the processor to cause the apparatus further to:
calculate an event importance score based on a corresponding weightage allocated to each alert information and a recency value at a point in time, the event importance score relating to an indication of importance of the event and the recency value relating to how recent the inputs are received.

20. The apparatus of claim 16, wherein the memory and the computer program is executed by the processor to cause the apparatus further to:
identify at least one of an image pattern from each of the plurality of inputs relating to the at least one event;
determine if the identified facial or object information matches at least one information that corresponds to a target pre-determined attribute information prior to grouping the pre-determined attribute of the input; and
associate the identified image pattern with a pre-determined attribute information if the identified information does not match at least one information that corresponds to a target pre-determined attribute information.

21. (canceled)

22. The apparatus of claim 16, wherein the memory and the computer program is executed by the processor to cause the apparatus further to:
identify at least one of an estimated number of a crowd information from each of the plurality of inputs relating to the at least one event;
identify at least one of a density information of the crowd information from each of the plurality of inputs relating to the at least one event;
identify at least one of a movement information of the crowd information from each of the plurality of inputs relating to the at least one event;
determine at least one of a type of the crowd information based on the estimated number of a crowd information, a density information and a movement information prior to grouping the pre-determined attribute of the input.

23. The apparatus of claim 17, wherein the memory and the computer program is executed by the processor to cause the apparatus further to:
rank the event importance score of the at least one group of location information, date information or pre-determined attribute information according to a set of pre-determined rules;
consolidate a grouping of the events based on their corresponding location information, time information and pre-determined attribute information in response to the ranking; and
present the events by their location, time and pre-determined attribute in response to the consolidation of the grouping, as alerts in the control room.

24. (canceled)
